(19) United States
(12) Patent Application Publication
(10) Pub. No.: US 2026/0359859 A1
(43) Pub. Date: Nov. 12, 2026

(54) DATA PLATFORM FOR MULTIMEDIA EXPOSURE DETERMINATIONS

(71) Applicant: AIM Sport Development AG, Lucerne (CH)

(72) Inventors: Adam John Holt, Kleinburg (CA); Adam Jarrell Smith, San Diego, CA (US)

(73) Assignee: AIM Sport Development AG, Lucerne (CH)

(21) Appl. No.: 19/669,044

(22) Filed: May 6, 2026

Related U.S. Application Data
(60) Provisional application No. 63/800,963, filed on May 6, 2025.

(51) Int. Cl. G06Q 30/0242

(52) U.S. Cl. CPC G06Q 30/0243; G06Q 30/0246

(57) ABSTRACT

The present disclosure provides a framework for processing exposure data corresponding to different properties along different multimedia vectors to calculate exposure value quotients and provide insights with regard to the different properties.

### CROSS-REFERENCE TO RELATED APPLICATIONS

The present patent application claims the priority benefit of U.S. Provisional Patent Application No. 63/800,963 filed May 6, 2025, the disclosures of which are incorporated by reference herein.

### FIELD

The present disclosure relates generally to a framework through which a data platform for determining multimedia exposure along different viewing vectors is implemented.

### BACKGROUND

In the advertisement and marketing space, advertisers often rely on traditional, linear television viewing data to determine the effectiveness and exposure of video and physical advertisements. For instance, advertisers often rely on marketing research companies to provide television viewing data that is generated using external devices and other methods of television viewing measurements to determine the level of exposure of their advertisements. However, with the advent of over-the-top (OTT), connected television (CTV), and other data streaming technologies, viewers are now able to consume multimedia programming through means other than traditional, linear television programming. Further, with the rising costs associated with these streaming technologies, some viewers may use illicit and/or unauthorized means to consume this multimedia programming. Thus, there is a need to determine the level of exposure for different advertisements through these alternative viewing methods so that advertisers may readily determine the effectiveness of these advertisements.

### SUMMARY

Disclosed embodiments provide a framework for processing exposure data corresponding to different properties along different multimedia vectors to calculate exposure value quotients and provide insights with regard to the different properties. According to some embodiments, a computer-implemented method is provided. The computer-implemented method comprises obtaining exposure data corresponding to a property along a set of multimedia vectors. The exposure data is obtained through a set of data partner servers operating in parallel. Further, each data partner server from the set of data partner servers is associated with one or more multimedia vectors of the set of multimedia vectors. The computer-implemented method further comprises processing the exposure data to generate a set of exposure values corresponding to the property and based on statistical metrics corresponding to the set of multimedia vectors. The computer-implemented method further comprises aggregating the set of exposure values to generate a total exposure value for the property. The computer-implemented method further comprises calculating an exposure value quotient (EVQ) for the property. The EVQ is calculated according to a median proportion of the total exposure value derived from a particular subset of multimedia vectors from the set of multimedia vectors. The computer-implemented method further comprises processing, through a machine learning algorithm, the EVQ and the set of exposure values to generate a set of insights for adjusting the statistical metrics to improve the set of exposure values for the property. The machine learning algorithm is trained using a dataset comprising sample exposure-related data and sample insights corresponding to the sample exposure-related data. The computer-implemented method further comprises providing the set of exposure values, the EVQ, and the set of insights. The computer-implemented method further comprises obtaining feedback corresponding to the set of insights and changes to the set of exposure values for other properties within a same class of properties as the property. The computer-implemented method further comprises retraining the machine learning algorithm by processing and updated dataset generated according to the feedback and the changes to the set of exposure values. The computer-implemented method further comprises processing new EVQs and new sets of exposure values corresponding to new properties through the retrained machine learning algorithm to generate new insights for adjusting new statistical metrics corresponding to the set of multimedia vectors and associated with the new properties.

In some embodiments, the particular subset of multimedia vectors comprises a social media exposure vector, an illicit streaming exposure vector, and an intellectual property (IP) exposure vector.

In some embodiments, the machine learning algorithm is implemented using natural language processing (NLP) to provide the set of insights using human-readable structures.

In some embodiments, the exposure data is obtained through one or more application programming interface (API) endpoints. Further, the exposure data is received at the one or more API endpoints through a set of PUT API calls from the set of data partners servers.

In some embodiments, the statistical metrics include a cost-per-mille metric corresponding to linear television advertising based on known costs associated with upfront media advertising slots and a level of exposure for advertisements presented in the upfront media advertising slots.

In some embodiments, the set of exposure values includes an exposure value corresponding to properties exposed through over-the-top (OTT), data streaming platforms, and social media platforms.

In some embodiments, the set of exposure values includes an exposure value corresponding to properties exposed through unauthorized reproduction of broadcasts provided through different unauthorized streaming services.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which an exposure analytics server system dynamically processes exposure data corresponding to different advertising properties along different multimedia vectors to calculate exposure value quotients and provide insights with regard to the different advertising properties in accordance with at least one embodiment;

FIG. 2 shows an illustrative example of an environment in which linear television data corresponding to different viewing households is aggregated and processed to determine the exposure value of different advertisements presented through linear television methods in accordance with at least one embodiment;

FIG. 3 shows an illustrative example of an environment in which OTT, CTV, and social media user engagement data are aggregated and processed to determine the exposure value of different advertisements presented through these methods in accordance with at least one embodiment;

FIG. 4 shows an illustrative example of an environment in which illicit streaming sites are monitored to determine the possible exposure value of different advertisements presented through illicit reproduction of multimedia content in accordance with at least one embodiment;

FIG. 5 shows an illustrative example of an interface through which exposure values corresponding to an advertising property along different multimedia vectors are provided in accordance with at least one embodiment;

FIG. 6 shows an illustrative example of an interface through which an exposure value quotient is calculated and presented for an advertising property in accordance with at least one embodiment;

FIG. 7 shows an illustrative example of a process for calculating exposure values for different advertising properties along different multimedia vectors and corresponding exposure value quotients in accordance with at least one embodiment; and

FIG. 8 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

As mentioned herein, the term “advertisements” or “ads” in sports sponsorships often refer to visible signage/branding on the side of a sports playing field (e.g., basketball court, baseball park, football field, etc.), an in-game promotion, a radio spot, a television commercial, a billboard, or any organic re-posting of sports content that contains a sponsors branding, and the like.

As mentioned herein, the term “multimedia vectors” refers to the different multimedia formats through which sporting events and corresponding sports sponsorships are presented. Multimedia vectors can include linear television formats, social media formats (e.g., social media platforms, OTT, CTV, other data streaming formats and services, etc.), illicit streaming formats (e.g., illicit streaming sites and services, etc.), and traditional intellectual property formats (e.g., billboards, promotions, etc.).

As mentioned herein, the term “exposure value quotient” refers to the estimated true value of a sports sponsorship in relation to the exposure value of the sports sponsorship through traditional multimedia vectors such as linear television formats.

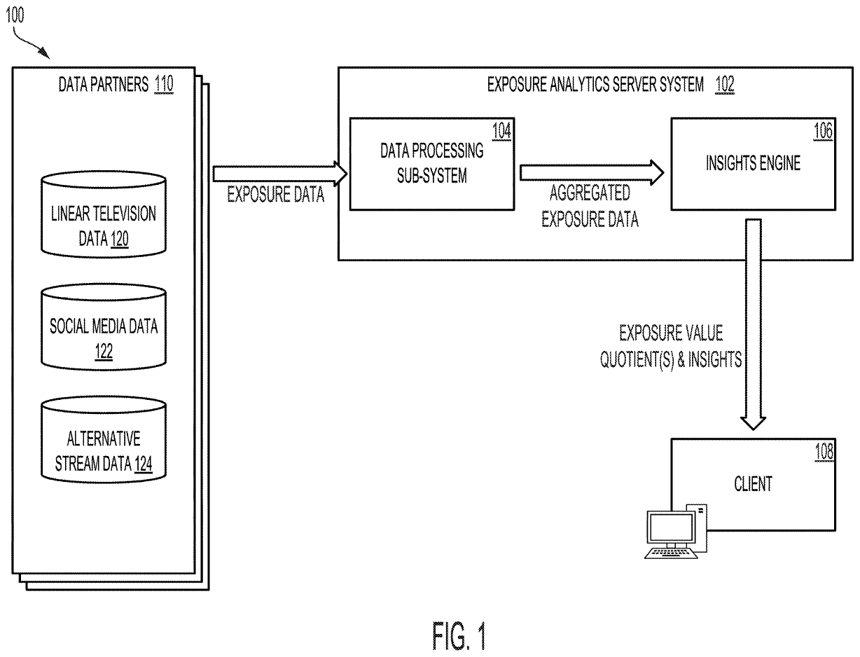

FIG. 1 shows an illustrative example of an environment 100 in which an exposure analytics server system 102 dynamically processes exposure data corresponding to different advertising properties along different multimedia vectors to calculate exposure value quotients and provide insights with regard to the different advertising properties in accordance with at least one embodiment. In the environment 100, an exposure analytics server system 102 dynamically processes exposure data from one or more data partner servers 110 to calculate the exposure value of different sports sponsorships along different multimedia vectors. As described in greater detail herein, these exposure values along different multimedia vectors may be aggregated and processed to determine, for each sports sponsorship, the exposure value quotient for the sports sponsorship and any insights that may provide a client device 108 with opportunities to further capitalize on their sports sponsorships.

In an embodiment, the exposure analytics server system 102 implements a data processing sub-system 104 that is configured to obtain and aggregate exposure data from one or more data partner servers 110 to determine the estimated exposure of different sports sponsorships along different multimedia vectors. Data partner servers 110 may include various databases 120-124 storing data associated with different multimedia vectors through which sports sponsorships may be presented to respective audiences. As illustrated in FIG. 1, the data partner servers 110 include a linear television database 120, a social media database 122, and an alternative stream database 124. It should be noted that the databases 120-124 illustrated in FIG. 1 are non-exhaustive illustrative examples of different sources of exposure data corresponding to different multimedia vectors and additional and/or alternative sources of exposure data may be provided. For example, data partner servers 110 may further include databases corresponding to augmented reality, virtual reality, location-based exposure data, and the like.

In an embodiment, the data partner servers 110 are implemented and configured to simultaneously and in parallel aggregate exposure data according to their assigned data source. For example, the data partner server configured to obtain and aggregate exposure data corresponding to linear or traditional television viewership may operate simultaneously and in parallel to another data partner server configured to obtain and aggregate data from different social media platforms and streaming services. As these data partner servers 110 operate independently from each other, each data partner server may transmit its aggregated exposure data from its corresponding database to the data processing sub-system 104 without need for a trigger from any other data partner server. In some instances, each data partner server may transmit its corresponding aggregated exposure data in response to a request from the data processing sub-system 104.

The linear television database 120 may include data corresponding to viewer exposure to different sports sponsorships through traditional television programming and advertisements. This data may be obtained through different data sources. For instance, exposure data corresponding to linear television viewership may be obtained through audimeters or other external devices implemented in viewer households. Audimeters, for example, may automatically and in real-time monitor and record what television programs are being viewed within a household and transmit this data to a marketing research company or other data partner server 110 for dissemination to interested parties (e.g., the exposure analytics server system 102, different client devices 108, etc.). For a televised sporting event, the sports sponsorships presented during the televised sporting event may be known (e.g., the content of advertisements presented within an arena or other sporting venue, the advertisements aired during the televised sporting event, etc.). Thus, the level of exposure related to different sports sponsorships may be determined based on this data.

The exposure data corresponding to linear television viewership may further include diaries or other self-reported data as provided by different viewers. For instance, in addition to audimeters, marketing research companies may provide different households with diaries, surveys, or other self-reporting mechanisms through which viewers within these households may indicate what television programs have been viewed with these households. The responses to these diaries, surveys, or other self-reporting mechanisms may be evaluated to identify what televised sporting events have been viewed and, accordingly, the exposure to different sports sponsorships presented during these televised sporting events.

In some instances, the linear television database 120 may further include data obtained through automatic content recognition (ACR) implemented on smart televisions. Similar to audimeters, a smart television that implements ACR may automatically record data corresponding to what is currently being displayed through the smart television, including different television programs. The smart television may automatically transmit this data to marketing research companies, broadcasters, data aggregators (including one or more data partner servers 110) for further processing. ACR data may be provided in real-time, which in turn allows for real-time determination of sports sponsorship exposure for different televised sporting events captured by different smart televisions.

The social media database 122 may include data corresponding to OTT, CTV, and other legitimate data streaming services through which viewers may access streamed sporting events and/or snippets of such sporting events (e.g., highlights, game summaries, commentaries, etc.) on demand. Viewership data corresponding to streamed sporting events and/or snippets of such sporting events may be obtained using ACR or other real-time data analysis. In some instances, a data partner server 110 may dynamically scrape any viewership statistics and comments from these data streaming services to gauge the level of interaction with streamed sporting events and/or snippets of such sporting events. From the viewership data and comments, the data partner server 110 may determine the level of exposure related to the different sports sponsorships presented during the sporting events.

The social media database 122 may further include engagement data from different social media platforms. In some instances, different sporting organizations (e.g., leagues, teams, etc.) may generate different posts through different social media platforms and that include snippets of different sporting events. Users of these social media platforms may engage with these posts, thereby exposing sports sponsorships presented within any provided sporting event snippets to these users. Thus, through scraping of different posts related to different sporting organizations, a data partner server 110 may process these posts to obtain exposure data for different sports sponsorships presented through these posts.

The alternative stream database 124 may include data corresponding to illicit or unauthorized reproduction of sporting event broadcasts provided through different illicit streaming services and sites. In an embodiment, a data partner server 110 can be implemented by a content monitoring service to monitor user interactions with content provided through illicit streaming services and sites. For instance, a content monitoring service may dynamically monitor illicit data streaming, downloads, torrents, and the like to gauge the pervasiveness of illicit content reproduction and viewership. Through this dynamic monitoring of user interaction with illicit or unauthorized reproductions of sporting event broadcasts, the content monitoring service may determine the level of exposure related to different sports sponsorships presented through these illicit or unauthorized reproductions.

In an embodiment, the data partner servers 110 include external servers (e.g., third-party servers that serve as data partners, etc.) that automatically collect the aforementioned data and provide the aforementioned data to a data processing sub-system 104 of the exposure analytics server system 102. It is appreciated that in at least one practical implementation, each database 120-124 shown can be provided in its own respective system (e.g., cloud storage system, and the like). In some instances, one or more databases 120-124 may be implemented by one or more external entities (e.g., other servers, other third-party data brokers, etc.) that may collect, aggregate, and store data therein for use by the data partner servers 110. In an embodiment, the data partner servers 110 maintain a persistent communications session with the data processing sub-system 104, through which the data partner servers 110 can automatically push the aforementioned data in real-time and as the data is received to the data processing sub-system 104.

In an embodiment, the data processing sub-system 104 of the exposure analytics server system 102 implements and exposes an application programming interface (API) through which the data partner servers 110 can transmit API calls to the data processing sub-system 104. For instance, this API exposes one or more API endpoints to the data partner servers 110 so that the data partner servers 110 may, via this API, transmit the exposure data from the different databases 120-124 to the data processing sub-system 104 for processing. In one or more embodiments, an API call is a request made by the data partner servers 110 to perform one or more API actions, such as retrieving information, updating information, deleting information, adding information, performing various operations, methods, functions, and the like. For instance, as the data partner servers 110 obtain, in real-time, exposure data from any of the databases 120-124 as this data is gathered from the aforementioned data sources, the data partner servers 110 may generate a PUT API call addressed to a data processing API endpoint of the API. In response to the PUT API call from the data partner servers 110, the data processing sub-system 104 may obtain and begin processing of the exposure data.

In an embodiment, the data processing sub-system 104 of the exposure analytics server system 102 obtains (such as through the API endpoint described above) and processes the exposure data from the different databases 120-124 to calculate the exposure value of the different sports sponsorships according to the different multimedia vectors evaluated (e.g., linear television, social media, alternative streaming, etc.). The exposure value according to the different multimedia vectors may be determined based on statistical cost-per-mille (CPM) metrics corresponding to the different multimedia vectors. CPM metrics may refer to the estimated cost for exposure of a particular advertisement through a form of media. This estimated cost may be determined through historical advertising campaign costs and the levels of exposure to these advertising campaigns over time.

In an embodiment, the base CPM metric used to determine the exposure value according to the different multimedia vectors is a historical CPM metric for traditional, linear television advertisements and sports sponsorships. For example, the data processing sub-system 104 may obtain the historical average CPM for linear television advertising based on the known costs associated with upfront media advertising slots and the number of impressions (e.g., level of exposure) for the advertisements presented in these advertising slots. Using this historical CPM value, the data processing sub-system 104 may calculate the exposure value for a sports sponsorship or other advertisement exposed through linear television viewership.

In an embodiment, the data processing sub-system 104 further calculates the exposure value for sports sponsorships or other advertisements exposed through OTT, CTV, and social media platforms. The exposure value for these sports sponsorships or other advertisements may be calculated using a different CPM value. For instance, the CPM for social media advertising exposure may differ from the historical average CPM for linear television advertising, as advertising costs associated with OTT, CTV, and social media platforms may not be to the scale of linear television advertising. The CPM for social media advertising exposure may be determined based on advertising insertion orders with different streaming advertisement sellers for different social media platforms, video sharing platforms, and legitimate streaming services. In some instances, the CPM for social media advertising exposure may be determined statistically based on data corresponding to estimated viewership of social media content compared to linear television content. For example, if the estimated viewership for social media content is lower than the estimated viewership for linear television content, the CPM for social media advertising exposure used to determine the exposure value of a sports sponsorship or other advertisement through social media vectors may be set to be proportionately lower than the CPM for linear television advertising exposure.

In some instances, the engagement data from different social media platforms (as obtained from the social media database 122) may be adjusted based on an estimated visibility factor. This estimated visibility factor may correspond to users sharing social media content with other users that may not engage with the primary source of the social media content (e.g., posts or content generated by sporting organizations, sports reporting entities, etc.). This sharing of social media content may be estimated according to an analysis of sample social media content and recording of sharing actions by users engaging with the sample social media content. As the application of an estimated visibility factor may increase the amount of social media advertising exposure for a sports sponsorship or other advertisement, the resultant exposure value for this sports sponsorship or other advertisement may proportionately increase.

In an embodiment, the data processing sub-system 104 further calculates the exposure value for sports sponsorships or other advertisements exposed through illicit or unauthorized reproduction of sporting event broadcasts provided through different illicit streaming services and sites. As the content through which these sports sponsorships or other advertisements are presented are illicitly taken from linear television broadcasts, the data processing sub-system 104 may apply the historical average CPM for linear television advertising used to determine the exposure value of sports sponsorships or other advertisements presented through linear television broadcasts.

In an embodiment, the data processing sub-system 104 incorporates the estimated intellectual property (IP) value of the underlying properties incorporated in the sports sponsorship or other advertisement. The IP value for a particular sports sponsorship or other advertisement may be estimated according to the total exposure value of the sports sponsorship or other advertisement through the different multimedia vectors described above. For instance, the data processing sub-system 104 may estimate the IP value of an underlying property incorporated in a sports sponsorship or other advertisement as being 30% of the total exposure value of the sports sponsorship or other advertisement through the different multimedia vectors. This estimated percentage may correspond to the potential boost in engagement with a brand or other entity as a result of exposure to the sports sponsorship or other advertisement associated with the brand or other entity, which may not be captured through traditional exposure metrics and measurements.

Once the data processing sub-system 104 has calculated the component exposure values along the different multimedia vectors and the IP value for a sports sponsorship or other advertisement, the data processing sub-system 104 may aggregate these values to obtain a total exposure value for the sports sponsorship or other advertisement. Additionally, the data processing sub-system 104 may calculate the proportion of this total exposure value that is attributable to social media, illicit streaming, and IP exposure. As traditional advertising exposure values are calculated using linear television advertising exposure data, identifying the proportion of total exposure value attributable to alternative multimedia vectors and IP can result in an understanding of potential advertising value (such as through a true CPM for an advertisement) that is not being captured through these traditional methods.

In an embodiment, the data processing sub-system 104 calculates an exposure value quotient (EVQ) corresponding to a potential markup that can be applied to a present CPM for a sports sponsorship or other advertisement to determine the potential exposure value that can be obtained from a sports sponsorship or other advertisement. For example, the data processing sub-system 104 may calculate the EVQ by identifying the median proportion of exposure value derived from social media, illicit streaming, and IP vectors (hereinafter “median alternative vector exposure value %”) according to different exposure characteristics (e.g., exposure by region, exposure by broadcast, exposure by sporting event, etc.) and applying the following formula:

$$EVQ = \frac{1}{1 - ( median alternative vector exposure value \% )}$$

In an embodiment, the data processing sub-system 104 provides the EVQ and underlying exposure values for a sports sponsorship or other advertisement to an insights engine 106 implemented by the exposure analytics server system 102. The insights engine 106 may be configured to translate the EVQ and underlying exposure values that are generated by the data processing sub-system 104 into insights that are direct, meaningful, and easily consumable. For instance, using natural language processing (NLP) or other machine learning algorithm/artificial intelligence, the insights engine 106 may generate insights in the form of sentences or other human-readable structure that allows a user of a client device 108 to readily consume the provided insights. The insights engine 106 may further populate pre-determined insights structures, built around client needs and different use cases, and automatically delivers these insights to the client device 108. In an illustrative example, such insights are provided as output through a user interface provided to client devices 108 accessing the exposure analytics server system 102. The insights engine may further provide automation that can be used to indicate or otherwise recommend specific actions that the client device 108 should take as a result of a provided insight. In some instances, the insights engine may use mathematical rules and/or machine learning/artificial intelligence techniques to separate high quality insights from lower quality insights derived from the exposure values and corresponding EVQ, so that only the highest quality (e.g., most interesting, most actionable, etc.) insights are displayed to clients.

In an embodiment, the machine learning algorithm or artificial intelligence implemented by the insights engine 106 is trained to identify any insights from the obtained EVQ and underlying exposure values generated by the data processing sub-system 104. The machine learning algorithm or artificial intelligence may be trained using a dataset of sample exposure-related data (e.g., historical EVQ and exposure values, hypothetical EVQ and exposure values, combinations of historical and hypothetical EVQ and exposure values, etc.) and sample insights corresponding to the sample exposure-related data (e.g., historical insights, hypothetical insights, combinations of historical and hypothetical insights, etc.). This dataset may be analyzed by the machine learning algorithm or artificial intelligence by converting the sample exposure-related data into a set of exposure-related data embeddings and the sample insights into a set of insight embeddings. The machine learning algorithm or artificial intelligence may classify the sample exposure-related data according to one or more vectors of similarity between the set of exposure-related data embeddings and the set of insight embeddings. In some instances, the machine learning algorithm or artificial intelligence may be implemented with a threshold that may be used to determine, based on the aforementioned embeddings and the one or more vectors of similarity, whether sample exposure-related data is sufficiently similar (e.g., satisfies the threshold by having a requisite amount of embeddings being within a level of tolerance of corresponding insight embeddings for a particular known insight) to a particular sample insight. If a sample exposure-related data does not satisfy the required threshold for classification to a particular known insight, the machine learning algorithm or artificial intelligence may be trained to determine that no insight can be derived from the sample exposure-related data.

In an embodiment, through the machine learning algorithm or artificial intelligence, the insights engine 106 may perform such clustering or classification of the aggregated exposure-related data as it is received from the data processing sub-system 104. Through this processing of the aggregated exposure-related data, the insights engine 106 may obtain partial matches among different known insights to detect any insights corresponding to the obtained exposure-related data and that may be presented to a client device 108. Further, if evaluation of embeddings of a particular data fails to satisfy the aforementioned threshold for identification of an insight that may be presented to a client device 108 based on the obtained aggregated exposure-related data, the machine learning algorithm or artificial intelligence may automatically process the aggregated exposure-related data according to other known insights and provide other insights that may be useful to the client device 108. As the insights engine 106 generates new insights through processing of the aggregated exposure-related data, the insights engine 106 may provide these insights to the client device 108.

In an embodiment, a client device 108 may start by looking at the EVQ for a particular sports sponsorship or other advertisement to determine the potential value that can be extracted from different sports sponsorships or other advertisements provided in relation to the client's properties (e.g., sports team, sports league, etc.). Further, through an interface, the client may determine the possible EVQ according to different exposure characteristics. For instance, if a particular sporting event associated with the client's team is very popular, the possible EVQ for sports sponsorships or other advertisements may be higher for this sporting event. As another illustrative example, if the exposure value for a sports sponsorship or other advertisement associated with a client's property differs according to the region in which the sporting event is presented, the client may use the corresponding exposure values and EVQs for these regions to define dynamic CPMs for advertisement slots associated with sporting events broadcast in these regions. In addition to reviewing the EVQ for a particular sports sponsorship or other advertisement, the client device 108 may further review any insights provided by the insights engine 106 and generated through the aforementioned machine learning algorithm or artificial intelligence.

In an embodiment, the insights engine 106 continuously updates the dataset used to train the aforementioned machine learning algorithm or artificial intelligence according to feedback provided by client devices 108 with regard to previously provided exposure values, EVQs, and insights. For example, if the insights engine 106, through the machine learning algorithm or artificial intelligence, provides an insight and recommendation to adjust the CPM for an advertisement slot for a particular class of sporting events broadcasts in a particular region but adherence to this insight and recommendation results in reduced exposure value (e.g., the adjustment in CPM results in lesser interest in obtaining advertisement slots for the particular class of sporting events broadcasts), the insights engine 106 may update the dataset to indicate that the generated insight and recommendation did not yield favorable or positive results. Further, the insights engine 106 may update the dataset to indicate the actual outcome resulting from the generated insight or recommendation. The machine learning algorithm or artificial intelligence may be retrained or otherwise updated through processing of this new dataset, which may result in updates to the set of insight embeddings according to the one or more vectors of similarity. These updates to the set of insight embeddings may result in a re-clustering or re-classification of historical/hypothetical aggregated exposure-related data from the updated dataset. Thus, as new aggregated exposure-related data is received, this data may be processed through the retrained or updated machine learning algorithm or artificial intelligence to generate new, more accurate insights and recommendations that may be presented to client devices 108.

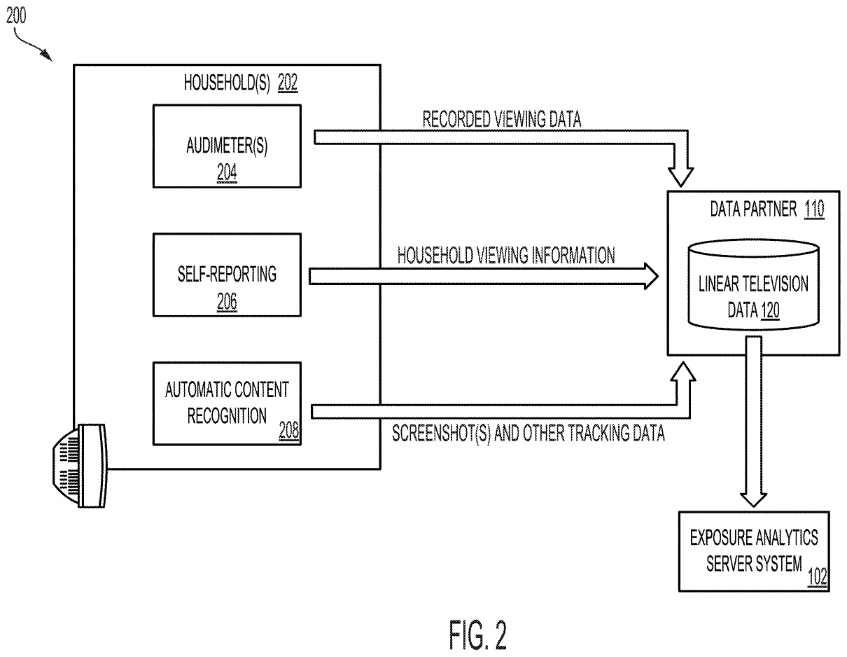

FIG. 2 shows an illustrative example of an environment 200 in which linear television data corresponding to different viewing households 202 is aggregated and processed to determine the exposure value of different advertisements presented through linear television methods in accordance with at least one embodiment. In the environment 200, a data partner server 110 that maintains a linear television database 120 may dynamically collect and store viewership data pertaining to different content broadcast through linear television methods. As noted above, this viewership data may be obtained through different linear television data sources. For instance, the data partner server 110 may obtain viewership (i.e., exposure) data through audimeters 204 or other external devices implemented in viewer households. As noted above, audimeters may automatically monitor and record what television programs are being viewed within a household 202 and transmit this data to the data partner server 110 for dissemination to interested parties (e.g., the exposure analytics server system 102, etc.). For a televised sporting event, the sports sponsorships or other advertisements presented during the televised sporting event may be known (e.g., the content of advertisements presented within an arena or other sporting venue, the advertisements aired during the televised sporting event, etc.). Thus, the level of exposure related to different sports sponsorships or other advertisements may be determined based on this data.

The data partner server 110 may further obtain exposure data corresponding to linear television viewership based on diaries or other methods of self-reporting 206 from different viewers in polled households 202. As noted above, a data partner server 110 may provide different households 202 with diaries, surveys, or other self-reporting mechanisms through which viewers within these households may indicate what television programs have been viewed with these households 202. The responses to these diaries, surveys, or other self-reporting mechanisms may be evaluated to identify what televised sporting events have been viewed and, accordingly, the exposure to different sports sponsorships presented during these televised sporting events.

As noted above, the data partner server 110 can further obtain linear television viewership data through the implementation of ACR, such as through smart televisions and other devices within different households 202. A smart television or other device that implements ACR may automatically record data corresponding to what is currently being displayed through the smart television or other device, including different television programs. The smart television or other device may automatically transmit this data to the data partner server 110 for further processing. ACR data may be provided in real-time, which in turn allows for real-time determination of sports sponsorship exposure for different televised sporting events captured by different smart televisions and other devices. The aforementioned data obtained from the different households 202 may be stored in the linear television database 120 and accessed by the exposure analytics server system 102 as described above to calculate the exposure value of sports sponsorships or other advertisements presented through linear television methods.

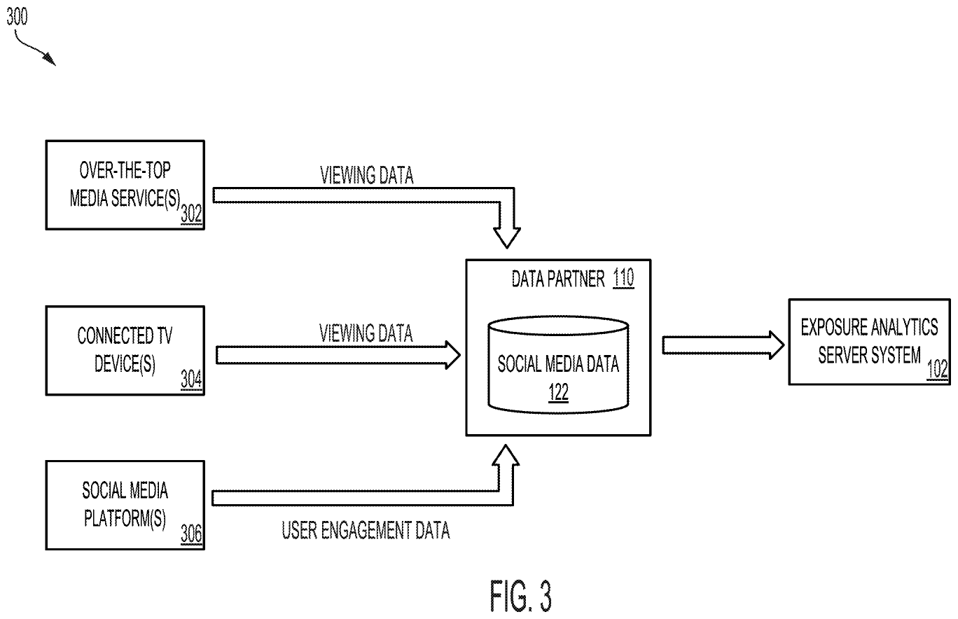

FIG. 3 shows an illustrative example of an environment 300 in which OTT, CTV, and social media user engagement data are aggregated and processed to determine the exposure value of different advertisements presented through these methods in accordance with at least one embodiment. In the environment 300, a data partner server 110 that maintains a social media database 122 may dynamically collect and store viewership data pertaining to different content disseminated (e.g., streamed, downloaded, etc.) through OTT media services 302, CTV devices 304, and different social media platforms 306. Viewership data obtained from OTT media services 302 and CTV devices 304 may be obtained through ACR or other real-time data analysis. For instance, through different OTT media services 302, viewers may access streamed sporting events and/or snippets of such sporting events on demand. Similarly, through different CTV devices 304, viewers may access a communications network (such as the Internet) and access these streamed sporting events and/or snippets of such sporting events on demand. In some instances, the data partner server 110 may dynamically scrape any viewership statistics and comments from OTT media services 302 to gauge the level of interaction with streamed sporting events and/or snippets of such sporting events. From the viewership data and comments, the data partner server 110 may determine the level of exposure related to the different sports sponsorships presented during the sporting events.

In an embodiment, the data partner server 110 further obtains user engagement data from one or more social media platforms 306 through which sporting events and/or snippets of such sporting events may be presented, commented on, and shared with other users. As noted above, different sporting organizations (e.g., leagues, teams, etc.) may generate different posts within different social media platforms 306 that include snippets of different sporting events. Users of these social media platforms 306 may engage with these posts, thereby exposing sports sponsorships and other advertisements presented within any provided sporting event snippets to these users. Thus, through scraping of different posts related to different sporting organizations, a data partner server 110 may process these posts to obtain exposure data for different sports sponsorships presented through these posts. The aforementioned data obtained from the OTT media services 302, CTV devices 304, and social media platforms 306 may be stored in the social media database 122 and accessed by the exposure analytics server system 102 as described above to calculate the exposure value of sports sponsorships or other advertisements presented through streamed sporting events, snippets of such sporting events, and social media posts.

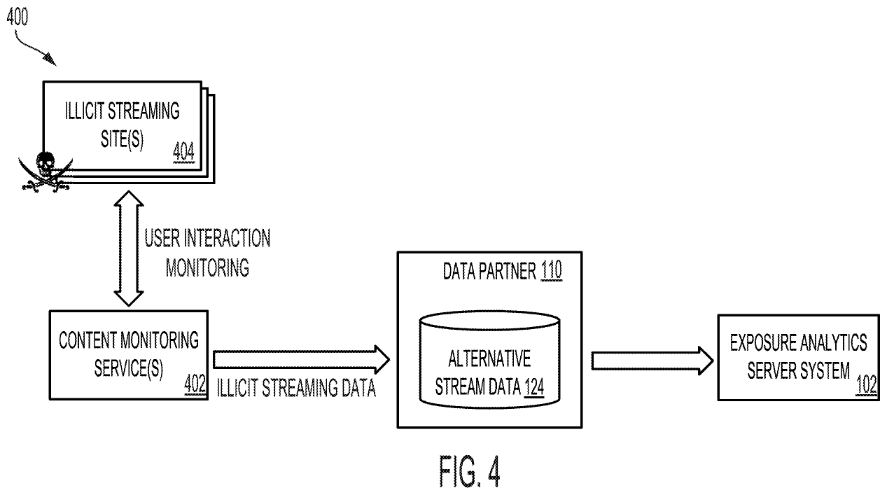

FIG. 4 shows an illustrative example of an environment 400 in which illicit streaming sites 404 are monitored to determine the possible exposure value of different advertisements presented through illicit reproduction of multimedia content in accordance with at least one embodiment. In the environment 400, a data partner server 110 may obtain exposure data from one or more content monitoring services 402 implemented to monitor user interactions with content provided through illicit streaming sites 404. The one or more content monitoring services 402, in some instances, may dynamically monitor illicit data streaming, downloads, torrents, and the like to gauge the pervasiveness of illicit content reproduction and viewership through the illicit streaming sites 404. Through this dynamic monitoring of user interactions with illicit or unauthorized reproductions of sporting event broadcasts, the one or more content monitoring services 402 may determine the level of exposure related to different sports sponsorships presented within these illicit or unauthorized reproductions. The data partner server 110 may obtain this data from the one or more content monitoring services 402 and store this data in the alternative stream database 124. This may allow the exposure analytics server system 102 to access this data as described above to calculate the exposure value of sports sponsorships or other advertisements presented through illicit reproduction of multimedia content corresponding to different sporting events.

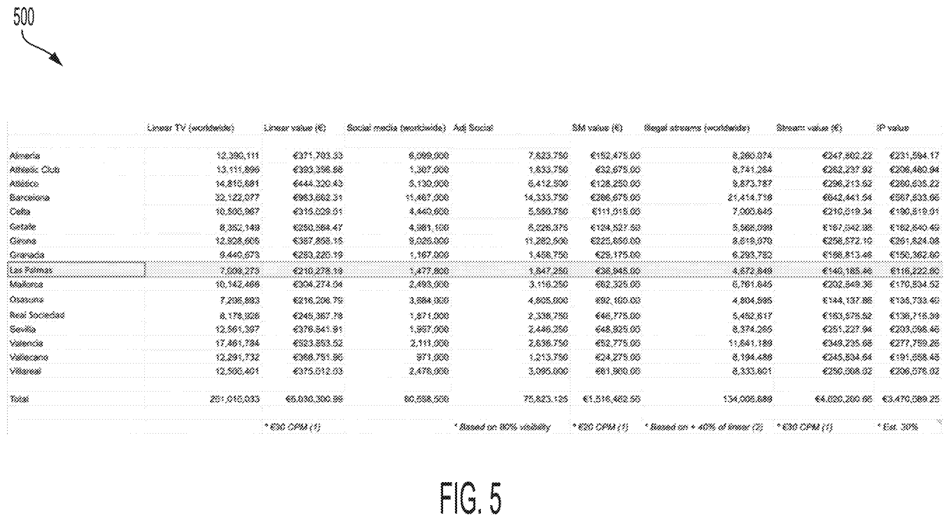

FIG. 5 shows an illustrative example of an interface 500 through which exposure values corresponding to an advertising property along different multimedia vectors are provided in accordance with at least one embodiment. As illustrated in FIG. 5, the exposure analytics server system 102 may provide an interface 500 through which the exposure analytics server system 102 may provide viewership and exposure values along different multimedia vectors and according to different CPM metrics per multimedia vector. For example, through the interface 500, the exposure analytics server system 102 may provide linear television exposure values, social media exposure values, illegal streaming exposure values, and IP exposure values for sports sponsorships or other advertisements that were made available for different broadcasts and presentations of sporting events. These exposure values may be provided at varying levels of granularity. For instance, the illustrative example provided in FIG. 5 corresponds to individual matches between Real Madrid (the team for which exposure values are being provided) and different opponents. For each opponent, the exposure analytics server system 102 may provide the exposure value along the different multimedia vectors and through which the corresponding match was presented to different audiences.

It should be noted that while the illustrative example of the interface 500 provided in FIG. 5 provides a breakdown of exposure values according to matches with different opponents, the exposure values may be organized according to different exposure characteristics. For instance, exposure values along different multimedia vectors may be aggregated according to the different regions in which different sporting events associated with a particular property are presented. As another illustrative example, exposure values along different multimedia vectors may be aggregated according to viewer demographics as determined through the different data partner servers 110 and evaluation of viewership data from the myriad sources described above. In some instances, a client 118, through the interface 500, may define the level of granularity for which exposure values are to be provided along the different multimedia vectors. This may help the client 118 understand how viewers are accessing content associated with a particular property and accordingly tailor how sports sponsorships and advertisement slots are sold to other entities.

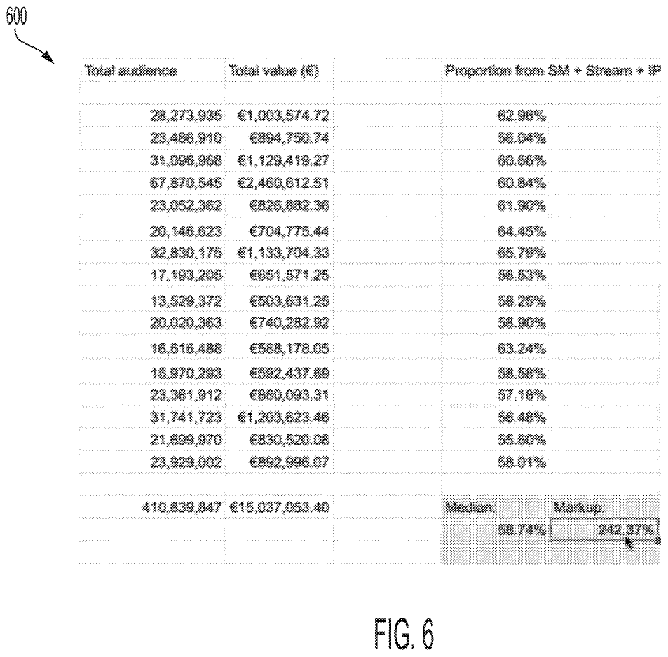

FIG. 6 shows an illustrative example of an interface 600 through which an exposure value quotient (EVQ) is calculated and presented for an advertising property in accordance with at least one embodiment. In an embodiment, the exposure analytics server system 102 aggregates the aforementioned exposure values along the different multimedia vectors to obtain a total exposure value for the sports sponsorship or other advertisement for each exposure characteristic (e.g., each individual opponent, each region, each demographic, etc.). Further, through the interface 600, the exposure analytics server system 102 may calculate and provide the proportion of this total exposure value that is attributable to social media, illicit streaming, and IP exposure. As noted above, as traditional advertising exposure values are calculated using linear television advertising exposure data, identifying the proportion of total exposure value attributable to alternative multimedia vectors and IP can result in an understanding of potential advertising value (such as through a true CPM for an advertisement) that is not being captured through these traditional methods.

Based on the proportion of the total exposure value that is attributable to social media, illicit streaming, and IP exposure, the exposure analytics server system 102 may calculate and provide, through the interface 600, an EVQ corresponding to a potential markup that can be applied to a present CPM for a sports sponsorship or other advertisement to maximize the exposure value that can be obtained from sports sponsorship or other advertisement slots made available during sporting events associated with a subject property. For example, the exposure analytics server system 102 may calculate the EVQ by identifying the median alternative vector exposure value % according to different exposure characteristics (e.g., exposure by region, exposure by broadcast, exposure by sporting event, etc.) and applying the formula described above.

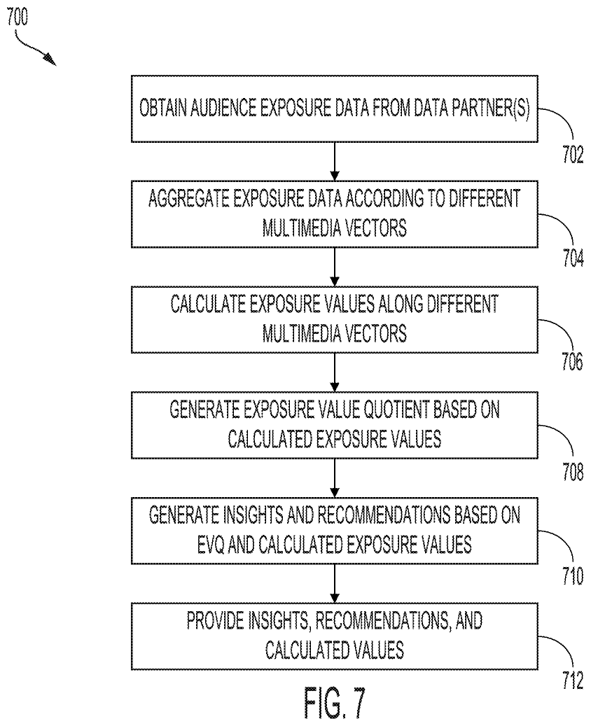

FIG. 7 shows an illustrative example of a process 700 for calculating exposure values for different advertising properties along different multimedia vectors and corresponding exposure value quotients in accordance with at least one embodiment. The process 700 may be performed by the exposure analytics server system 102. At step 702, the exposure analytics server system 102 may obtain audience exposure data from one or more data partner servers. As noted above, this exposure data may include linear television exposure data, social media exposure data, and illicit streaming exposure data.

At step 704, the exposure analytics server system 102 may aggregate the exposure data according to the different multimedia vectors (e.g., linear television, social media, illicit streaming, and IP) and, at step 706, calculate the exposure values using estimated CPMs for each vector. At step 708, based on the calculated exposure values the exposure analytics server system 102 may generate an EVQ for the corresponding property and, at step 710, generate insights and recommendations based on the EVQ and calculated exposure values and according to selected exposure characteristics. At step 712, the exposure analytics server system 102 may provide these insights, recommendations, and calculated values (EVQ, exposure values, etc.) to a client.

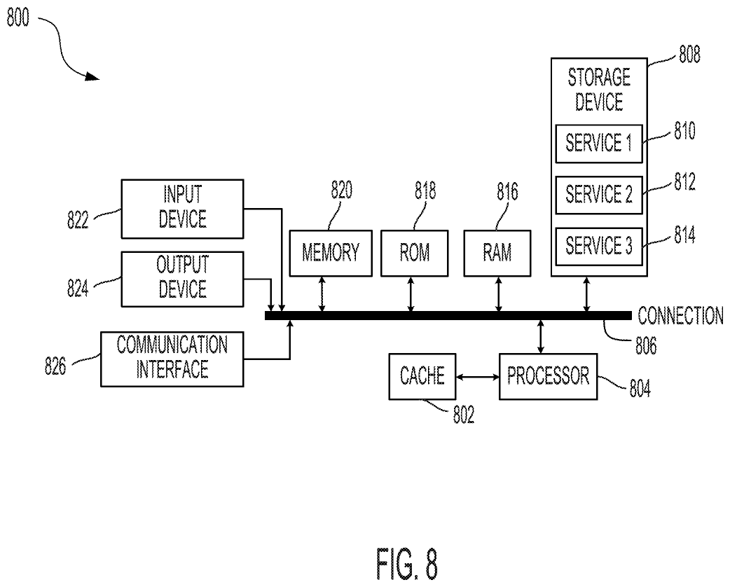

FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1 810, service 2 812, and service 3 814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDNO modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
obtaining exposure data corresponding to a property along a set of multimedia vectors, wherein the exposure data is obtained through a set of data partner servers operating in parallel, and wherein each data partner server from the set of data partner servers is associated with one or more multimedia vectors of the set of multimedia vectors;
processing the exposure data to generate a set of exposure values corresponding to the property and based on statistical metrics corresponding to the set of multimedia vectors;
aggregating the set of exposure values to generate a total exposure value for the property;
calculating an exposure value quotient (EVQ) for the property, wherein the EVQ is calculated according to a median proportion of the total exposure value derived from a particular subset of multimedia vectors from the set of multimedia vectors;
processing, through a machine learning algorithm, the EVQ and the set of exposure values to generate a set of insights for adjusting the statistical metrics to improve the set of exposure values for the property, wherein the machine learning algorithm is trained using a dataset comprising sample exposure-related data and sample insights corresponding to the sample exposure-related data;
providing the set of exposure values, the EVQ, and the set of insights;
obtaining feedback corresponding to the set of insights and changes to the set of exposure values for other properties within a same class of properties as the property;
retraining the machine learning algorithm by processing and updated dataset generated according to the feedback and the changes to the set of exposure values; and
processing new EVQs and new sets of exposure values corresponding to new properties through the retrained machine learning algorithm to generate new insights for adjusting new statistical metrics corresponding to the set of multimedia vectors and associated with the new properties.

2. The computer-implemented method of claim 1, wherein the particular subset of multimedia vectors comprises a social media exposure vector, an illicit streaming exposure vector, and an intellectual property (IP) exposure vector.

3. The computer-implemented method of claim 1, wherein the machine learning algorithm is implemented using natural language processing (NLP) to provide the set of insights using human-readable structures.

4. The computer-implemented method of claim 1, wherein the exposure data is obtained through one or more application programming interface (API) endpoints, and wherein the exposure data is received at the one or more API endpoints through a set of PUT API calls from the set of data partners servers.

5. The computer-implemented method of claim 1, wherein the statistical metrics include a cost-per-mille metric corresponding to linear television advertising based on known costs associated with upfront media advertising slots and a level of exposure for advertisements presented in the upfront media advertising slots.

6. The computer-implemented method of claim 1, wherein the set of exposure values includes an exposure value corresponding to properties exposed through over-the-top (OTT), data streaming platforms, and social media platforms.

7. The computer-implemented method of claim 1, wherein the set of exposure values includes an exposure value corresponding to properties exposed through unauthorized reproduction of broadcasts provided through different unauthorized streaming services.

8. A system, comprising:
one or more processors; and
memory storing thereon instructions that, as a result of being executed by the one or more processors, cause the system to:
obtain exposure data corresponding to a property along a set of multimedia vectors, wherein the exposure data is obtained through a set of data partner servers operating in parallel, and wherein each data partner server from the set of data partner servers is associated with one or more multimedia vectors of the set of multimedia vectors;
process the exposure data to generate a set of exposure values corresponding to the property and based on statistical metrics corresponding to the set of multimedia vectors;
aggregate the set of exposure values to generate a total exposure value for the property;
calculate an exposure value quotient (EVQ) for the property, wherein the EVQ is calculated according to a median proportion of the total exposure value derived from a particular subset of multimedia vectors from the set of multimedia vectors;
process, through a machine learning algorithm, the EVQ and the set of exposure values to generate a set of insights for adjusting the statistical metrics to improve the set of exposure values for the property, wherein the machine learning algorithm is trained using a dataset comprising sample exposure-related data and sample insights corresponding to the sample exposure-related data;
provide the set of exposure values, the EVQ, and the set of insights;
obtain feedback corresponding to the set of insights and changes to the set of exposure values for other properties within a same class of properties as the property;
retrain the machine learning algorithm by processing and updated dataset generated according to the feedback and the changes to the set of exposure values; and
process new EVQs and new sets of exposure values corresponding to new properties through the retrained machine learning algorithm to generate new insights for adjusting new statistical metrics corresponding to the set of multimedia vectors and associated with the new properties.

9. The system of claim 8, wherein the particular subset of multimedia vectors comprises a social media exposure vector, an illicit streaming exposure vector, and an intellectual property (IP) exposure vector.

10. The system of claim 8, wherein the machine learning algorithm is implemented using natural language processing (NLP) to provide the set of insights using human-readable structures.

11. The system of claim 8, wherein the exposure data is obtained through one or more application programming interface (API) endpoints, and wherein the exposure data is received at the one or more API endpoints through a set of PUT API calls from the set of data partners servers.

12. The system of claim 8, wherein the statistical metrics include a cost-per-mille metric corresponding to linear television advertising based on known costs associated with upfront media advertising slots and a level of exposure for advertisements presented in the upfront media advertising slots.

13. The system of claim 8, wherein the set of exposure values includes an exposure value corresponding to properties exposed through over-the-top (OTT), data streaming platforms, and social media platforms.

14. The system of claim 8, wherein the set of exposure values includes an exposure value corresponding to properties exposed through unauthorized reproduction of broadcasts provided through different unauthorized streaming services.

15. A non-transitory computer-readable storage medium storing thereon executable instructions that, as a result of being executed by one or more processors of a computer system, cause the computer system to:
obtain exposure data corresponding to a property along a set of multimedia vectors, wherein the exposure data is obtained through a set of data partner servers operating in parallel, and wherein each data partner server from the set of data partner servers is associated with one or more multimedia vectors of the set of multimedia vectors;
process the exposure data to generate a set of exposure values corresponding to the property and based on statistical metrics corresponding to the set of multimedia vectors;
aggregate the set of exposure values to generate a total exposure value for the property;
calculate an exposure value quotient (EVQ) for the property, wherein the EVQ is calculated according to a median proportion of the total exposure value derived from a particular subset of multimedia vectors from the set of multimedia vectors;
process, through a machine learning algorithm, the EVQ and the set of exposure values to generate a set of insights for adjusting the statistical metrics to improve the set of exposure values for the property, wherein the machine learning algorithm is trained using a dataset comprising sample exposure-related data and sample insights corresponding to the sample exposure-related data;
provide the set of exposure values, the EVQ, and the set of insights;
obtain feedback corresponding to the set of insights and changes to the set of exposure values for other properties within a same class of properties as the property;
retrain the machine learning algorithm by processing and updated dataset generated according to the feedback and the changes to the set of exposure values; and
process new EVQs and new sets of exposure values corresponding to new properties through the retrained machine learning algorithm to generate new insights for adjusting new statistical metrics corresponding to the set of multimedia vectors and associated with the new properties.

16. The non-transitory computer-readable storage medium of claim 15, wherein the particular subset of multimedia vectors comprises a social media exposure vector, an illicit streaming exposure vector, and an intellectual property (IP) exposure vector.

17. The non-transitory computer-readable storage medium of claim 15, wherein the machine learning algorithm is implemented using natural language processing (NLP) to provide the set of insights using human-readable structures.

18. The non-transitory computer-readable storage medium of claim 15, wherein the exposure data is obtained through one or more application programming interface (API) endpoints, and wherein the exposure data is received at the one or more API endpoints through a set of PUT API calls from the set of data partners servers.

19. The non-transitory computer-readable storage medium of claim 15, wherein the statistical metrics include a cost-per-mille metric corresponding to linear television advertising based on known costs associated with upfront media advertising slots and a level of exposure for advertisements presented in the upfront media advertising slots.

20. The non-transitory computer-readable storage medium of claim 15, wherein the set of exposure values includes an exposure value corresponding to properties exposed through over-the-top (OTT), data streaming platforms, and social media platforms.

21. The non-transitory computer-readable storage medium of claim 15, wherein the set of exposure values includes an exposure value corresponding to properties exposed through unauthorized reproduction of broadcasts provided through different unauthorized streaming services.
